(19) United States
(12) Patent Application Publication
(10) Pub. No.: US 2026/0054869 A1
(43) Pub. Date: Feb. 26, 2026

(54) TRANSFER DEVICE FOR TRANSFERRING AN ARRAY OF DOSES OF MEDICINES

(71) Applicant: Global Factories Total Engineering and Manufacturing B.V., 's-Gravenhage (NL)

(72) Inventors: Richard Rudolf Theodoor VAN DEN BRINK; Bart LEMS

(21) Appl. No.: 19/111,233

(22) PCT Filed: Sep. 13, 2023
(86) PCT No.: PCT/NL2023/050471

§ 371 Date: Mar. 12, 2025

(30) Foreign Application Priority Data
Sep. 13, 2022 (NL) 2033015

(51) Int. Cl. B65B 5/10; B65B 39/00; B65B 39/14

(52) U.S. Cl. CPC B65B 5/103; B65B 39/005; B65B 39/14; B65B 2039/009

(57) ABSTRACT

A transfer device for transferring an array of doses of medicines, the transfer device comprising a body extending along a main axis between a top face located at an upper part of the body and a bottom face located at a lower part of the body, the top face including a group of entrance openings arranged in an entrance matrix in a plane transverse to the main axis at the level of the top face, the entrance openings each being arranged to receive a dose of medicines of the array, the body comprising a bundle of channels for passing doses of medicines therethrough, each channel extending along the body from a single entrance opening of the group of entrance openings to a single exit opening of a group of exit openings arranged in an exit matrix in a plane transverse to the main axis of the body at the level of the bottom face, at least one of the channels extending along the body with a component transverse to the main axis of the body so as to transpose the array of doses of medicines from a first spatial configuration corresponding to the entrance matrix to a second spatial configuration corresponding to the exit matrix.

The invention generally relates to a transfer device for transferring an array of doses of medicines, a packaging device and a medicine dose inspection device.

At facilities where large amounts of doses of medicines are distributed, such as pharmacies, hospitals and nursing homes, doses of said medicines need to be sorted and inspected to help ensure that a patient takes the correct medicine in the correct quantity at the correct time and day. In order to reduce errors in distributing doses of medicines, devices have been developed to automate this process. Example of such devices are packaging devices and medicine dose inspection devices.

Packaging devices are used to package doses of medicines for patients and assist them with determining on when to take the correct doses. For example, the packaging devices can distribute the doses of medicines among the cavities of a blister tray or a string of pouches. The blister tray can be arranged such that it comprises an array of cavities, each cavity representing an intake moment corresponding to a time and a day of the week. For example, in a first direction of the array, the days Monday through Sunday are represented by 7 cavities. In a second direction of the array, time of day are represented by ‘Morning’, ‘Afternoon’, ‘Evening’ and ‘Night’ by 4 cavities. This would result in a 4×7 array, comprising of 28 cavities. A patient would then be able to take dose of medicine provided in a cavity corresponding to the prescribed day and time.

Medicine dose inspection devices are used to inspect larger doses of medicines, i.e. multiple medicines per dose. This can for example be done by dispensing doses of medicines from a dispenser on a table, for example in a grid. The doses of medicines are then checked, to verify that indeed the correct number and types of medicines are provided for each dose on the grid locations on the table. This can either be done by a person, a computer or by a person assisted by a computer. Especially when a computer, using vision technology, is used, sufficient space on the table is important as vision technology can have problems with medicine recognition and/or counting accuracy if doses of medicines overlap.

Commonly used packaging devices and medicine dose inspection devices have limited flexibility when it comes to providing medicines in an array, whether it is a blister tray, pouches or an array on an inspection table. For example, the packaging device is arranged to only fill cavities of certain arrays such as 4×7, have a fixed diameter and wherein the cavities are placed at a certain diameter from each other. As a result, if a different array size is required or if the dimensions of the blister tray or the pouches of a string differ from the original design, a new or adapted machine is required. This results in less flexibility in providing doses of medicine to a patient and when inspecting medicine doses, as it is often financially not feasible to purchase a new machine.

Thereto, the invention provides for a transfer device, in particular a transfer device according to claim 1. The transfer device comprises a body extending along a main axis between a top face located at an upper part of the body and a bottom face located at a lower part of the body. The top face includes a group of entrance openings arranged in an entrance matrix in a plane transverse to the main axis at the level of the top face. The entrance openings each are arranged to receive a dose of medicines of the array, the body comprises a bundle of channels for passing doses of medicines therethrough. Each channel extends along the body from a single entrance opening of the group of entrance openings to a single exit opening of a group of exit openings arranged in an exit matrix in a plane transverse to the main axis of the body at the level of the bottom face. At least one of the channels extends along the body with a component transverse to the main axis of the body so as to transpose the array of doses of medicines from a first spatial configuration corresponding to the entrance matrix to a second spatial configuration corresponding to the exit matrix.

The transfer device can change the spacing between doses of an array of medicines, for example increase or decrease the spacing. In other words, the transfer device allows for the transfer of an array with spacing, for example spacing dictated by a machine, to an array with reduced or increased spacing. This allows to adapt to other spacing standards than used in the machine without need for manual transfer of the individual doses of medicines. Reducing or eliminating the need for manual transfer can reduce the amount of labor needed, increase the speed of transfer and reduce the risk of introducing errors in the array. In addition, it can be possible that transfer device can provide for additional positions of medicines in the array, for example when there is no space in the array provided by the medicine dispensing machine or when the machine is unable to dispense in the preferred array shape.

Furthermore, it may also be possible to form a wide spacing for optimal optical recognition on a medicine inspection table, for example to reduce the risk of overlap of medicines within a dose to be inspected. The transfer device can also be used to transfer from a wide spacing to a more compact spacing in a tray or blister, which can be used to put several medicines doses on top of each other. The doses of medicines can be a compound, or group, of medicines and/or individual medicines. When placed in to a tray or blister, the location in the tray can be indicative for the intake moment of the medicines. This can be done in a grid, for example with a first direction being indicative for the day of the week and a second direction being indicative for a timeslot. If a patient or group of patients do not need a medicine on a certain time and day, the corresponding position in the tray or blister can be left vacant.

In practice, the array of doses of medicines is packaged in blister trays or pouches, for example a planar carrier with a matrix of cavities comprising of a disposable planar sheet of thermoplastic material with a matrix of cups, or blisters, thermoformed therein that have been sealed with a cover and labeled week days on a column and intake moments on a row. The cavities with medicine doses may be separable, for example via score lines. As an alternative, reusable individual cups detachably mounted in a carrier frame are used. For patient safety, the content of the doses of medicines may be checked, recorded and sealed so that the patient receives the right dose at the right moment.

The channels of the bundle can diverge relative to each other while extending from the entrance opening to the exit opening. Said diverging allows for the increase of the pitch, spacing and/or dimensions of the exit openings in the plane of the exit matrix relative to the spacing and/or dimensions of the entrance openings in the plane of the entrance matrix.

The channels of the bundle can converge relative to each other while extending from the entrance opening to the exit opening. Said convergence allows for the decrease in the pitch spacing and/or dimensions of the exit openings in the plane of the exit matrix relative to the spacing and/or dimensions of the entrance openings in the plane of the entrance matrix. The convergence can happen in one direction, for example along an X-axis, diverge in another direction, for example a Y-axis. Alternatively, the convergence or divergence can be both be along the X-axis and Y-axis. As a further alternative, convergence may be provided in a direction in the first step and divergence in the same direction in the second step or vice versa.

At least one of the channels can extend along the main axis of the body free of component transverse to the main axis of the body, for example in the center or along an edge of the body.

The channels can be defined by one or more circumferential walls. The circumferential walls can enclose the channels. The walls can be thin walls, relative to the dimensions to the opening of the channels. Having relative thin walls can result in a relatively large channels compared to the medicines. As a result, blockage caused by medicines that are stuck in the channels can be reduced. The channels provided in the body can share a wall, which can result in a further increase of the channel size, thereby further decreasing the chance of blockage. Additionally, or alternatively, the walls may provide for rectangularly shaped channels, which can further increase the channel size and further decreasing the chance of blockage. Chance of blockage may be further reduced by providing walls that are relatively smooth, preferably linear or in a straight line in axial direction of the channel.

A channel may be defined by circumferential walls, and the walls of adjacent channels may be interspaced from each other. In addition, the walls may be constructed from a transparent material, allowing for the visual inspection of the channels for example to look for the presence of medicines.

The entrance openings of the entrance matrix and/or exit openings of the exit matrix can be arranged on a pitch in at least first direction in the plane of the matrix. The pitch can be a constant pitch, providing evenly spaced grid positions. Additionally, or alternatively, the entrance matrix and/or exit openings can be arranged on a pitch in a second direction in the plane of the matrix. The second direction can be in a direction transverse to the first direction. This pitch can also be a constant pitch, thereby providing evenly spaced grid positions. The pitch in the first direction and the pitch in the second direction can be of equal or different length. Furthermore, the pitch of the entrance matrix can be equal or different to the pitch of the exit openings in the first and/or second direction. Different pitch configurations can allow for different geometrical dimensions of the matrix adapter and can therefore be used on a wide range of machines.

The channels, entrance openings and/or exit openings can include or cooperate with a hatch that is movable between a first state in which it blocks an opening or channel for medicines and a second state in which it leaves an opening or channel free for medicines. The hatch can be provided at the entrance opening and/or exit opening as well as in the channel. The hatch can for example be or include a drop bottom, a trap door, or a slide plate. Additionally, or alternatively, the hatch can be arranged to individually open or block a corresponding channel or the hatch can be arranged to open or block multiple channels. Such a hatch can be used to prevent medicines from falling through wrong channels, for example by providing the hatch near the opening. If the hatch is provided in the channel or near the exit opening, the hatch can be used to collect medicines in the channel, for example for inspection, before opening the hatch and thereby releasing the medicines.

The body can include two mutually transversely arranged sets of a number of mutually parallel planar strips to define openings and channels therebetween. This can allow for a relatively thin wall compared to the size of the openings and thereby allowing almost the full area provided in the plane transverse to the main body to be available for the passage of medicines. The strips can be secured to each other with slots with which the strips can be slid into each other. The strips can be cut from a plate, such as a cardboard, steel or plastic plate and forming rigid or flexible strips. Alternatively, the body can be integrally formed, for example by drilling, molding, die casting and/or milling openings in a block or 3D printing. An additional alternative can be the passages are formed by bundling tubes in an array, each tube forming a channel.

At least one of the channels can extend along the main axis of the body free of component transverse to the main axis of the body, for example in the center or along an edge of the main body.

The transfer device can include multiple stages along its main axis. Multiple stages can simplify the spatial arrangement of the transfer device. For example, a first stage can comprise one or more of the channels extending with a component transverse to the main axis in a first transverse direction only and a second stage can comprise one or more channels that extend with a component transverse to the main axis in a second transverse direction, wherein the second transverse direction is perpendicular to the first transverse direction only.

Furthermore, the invention provides for a packaging device, including a frame having a top arranged to receive a first carrier with a matrix of cavities for receiving doses of medicines therein having a first spatial configuration and a bottom arranged to receive a second carrier with matrix of cavities for receiving doses of medicines therein having a second spatial configuration and a transfer device as previously described, included in the frame with openings in its top face arranged to cooperate with cavities of the first carrier and openings in its bottom face arranged to correspond with cavities of the second carrier so as to transpose an array of doses of medicines of the first carrier from a first spatial configuration to a second spatial configuration. The first carrier can include hatches, for example drop bottoms aligned on the cavities of the first carrier, that can be moved from the first and second state via a lever on the frame. When the hatches are in the second, open, state a medicine can fall from the cavity of the first carrier through the entrance openings of the transfer device via the channel through the exit opening into a corresponding cavity of the second carrier. The second carrier can be slid into the frame such that the openings such that the cavities correspond with the exit openings of the transfer device. Preferably, the transfer device can only have a single mounting orientation in which the spatial position of the entrance openings corresponds to the spatial position of the cavities of the first carrier and in which the spatial position of the exit openings corresponds to the spatial position of the cavities of the second carrier.

In addition, the invention provides for a medicine dose inspection device comprising an inspection plane with an inspection matrix of substantially planar inspection positions on which doses of medicines may be paced to be inspected and a transfer device as previously described. In particular a transfer device in which the pitch, spacing and/or dimension of the exit openings in the plane of the exit matrix are reduced relative to the pitch, spacing and/or dimension of the entrance openings in the plane of the entrance matrix. The inspection positions are arranged to correspond with the entrance openings of the entrance matrix. The inspection positions comprise a hatch that is movable between a first state in which it blocks its corresponding entrance opening and a second state in which it leaves its corresponding entrance opening free to allow passage of the dose of medicine. The medicine dose inspection device further comprises an inspected dose carrier with a matrix of cavities for receiving inspected doses of medicines therein. In an inspection matrix the spatial configuration of the array of doses of medicines is relatively large, or extended, compared to the spatial configuration of the array of doses of medicines from the machine such that it can allow for the placement of a plurality of medicines in dose next to each other without overlap. The doses of medicines can then be inspected, for example if the correct type of medicine and the correct number of doses has been provided, using indicative lights and/or cameras. The inspection plane of the medicine dose inspection device can be provided with a surface the presents good contrast and/or reflection of camera lighting. In addition, a vision system, for example connected to a computer running inspection software, can be used.

The invention further provides for a method of transferring medicines, in particular using a transfer device as described above, wherein doses of an array of doses of medicines are each passed through one of a bundle of channels having a main axis. At least one of the channels extends with a component of movement transverse to the main axis, so that the medicines are transposed from a first spatial configuration corresponding to an entrance matrix of entrance openings of the channels to a second spatial configuration corresponding to an exit matrix of openings of the channels.

The doses of medicine can be passed through channels in a first stage of the bundle with a component of movement transverse to the main axis in first transverse direction only, and in a second stage with a component of movement transverse to the main axis in second transverse direction, perpendicular to the first direction only.

Further advantageous aspects of the invention are set out in the description and appended claims.

The technical features described in the paragraphs can be isolated from the context, and the isolated technical features from the different paragraphs can be combined. Such combinations are herewith specifically disclosed in this description.

The invention will further be elucidated on the basis of exemplary embodiments which are represented in the drawings. The exemplary embodiments are given by way of non-limitative illustration of the invention.

In the drawings:

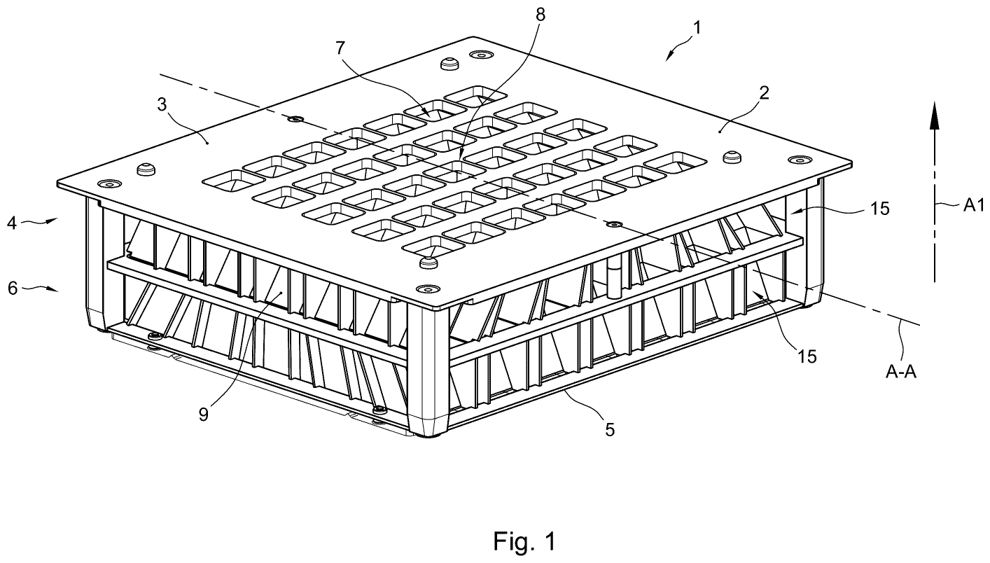

FIG. 1 shows an isometric overview of an example of transfer device for transferring an array of doses of medicines;

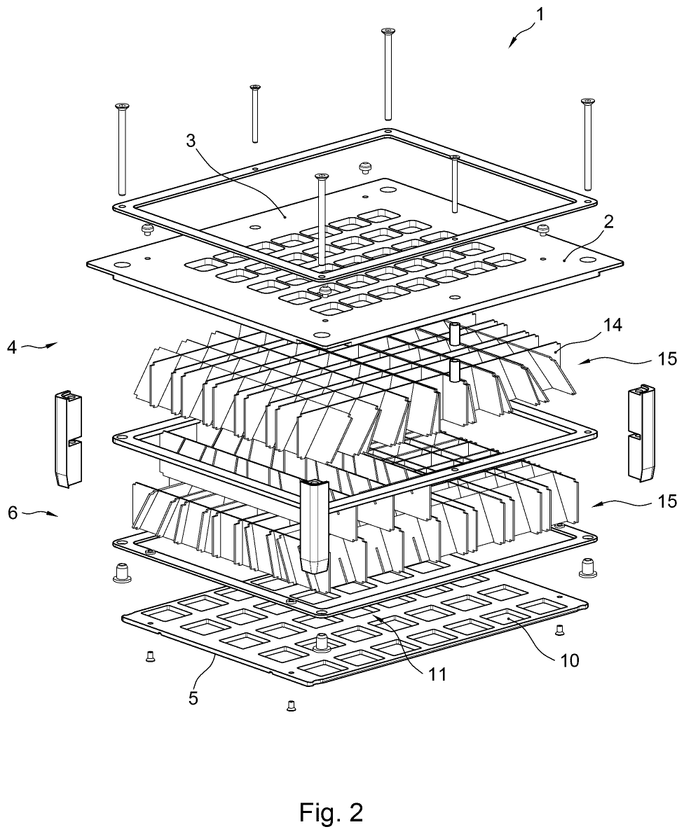

FIG. 2 shows an exploded view of the transfer device for transferring an array of doses of medicines of FIG. 1.;

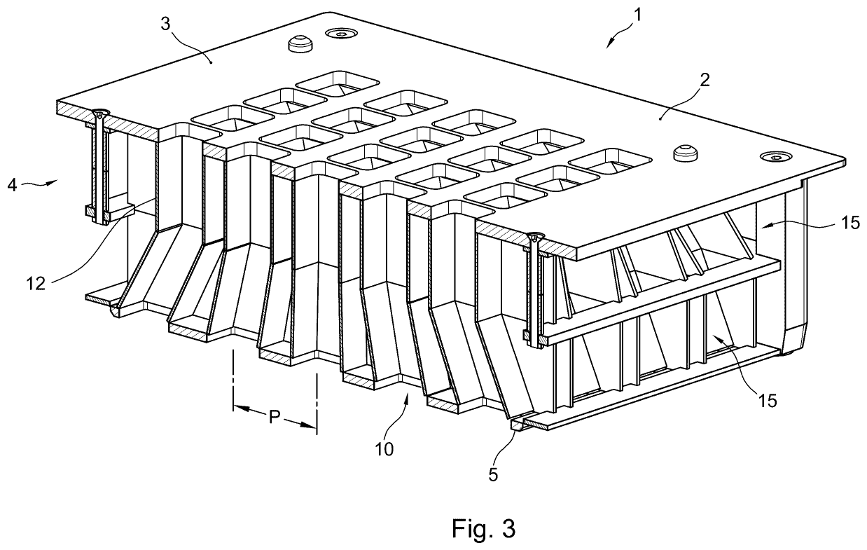

FIG. 3 shows a cross-sectional isometric overview of the transfer device for transferring an array of doses of medicines along the A-A line of FIG. 1;

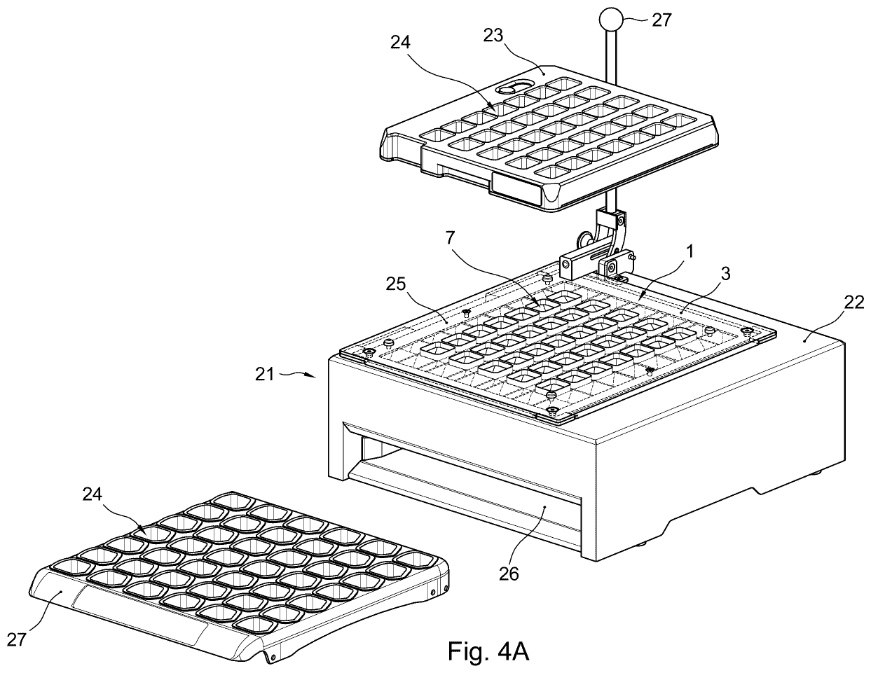

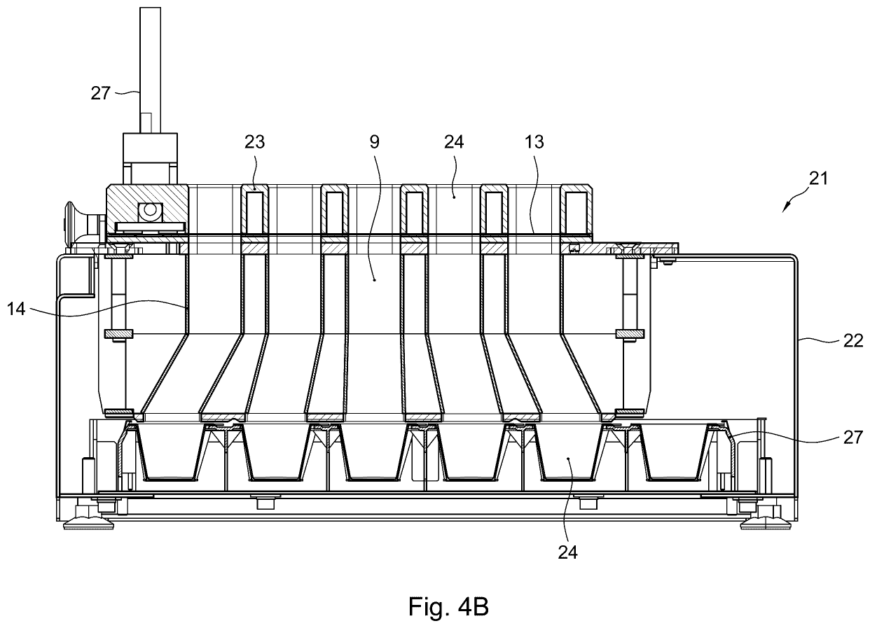

FIG. 4A shows a schematic isometric overview of a medicine packaging device;

FIG. 4B shows a cross-sectional side view of the medicine packaging device along the B-B line of FIG. 4A;

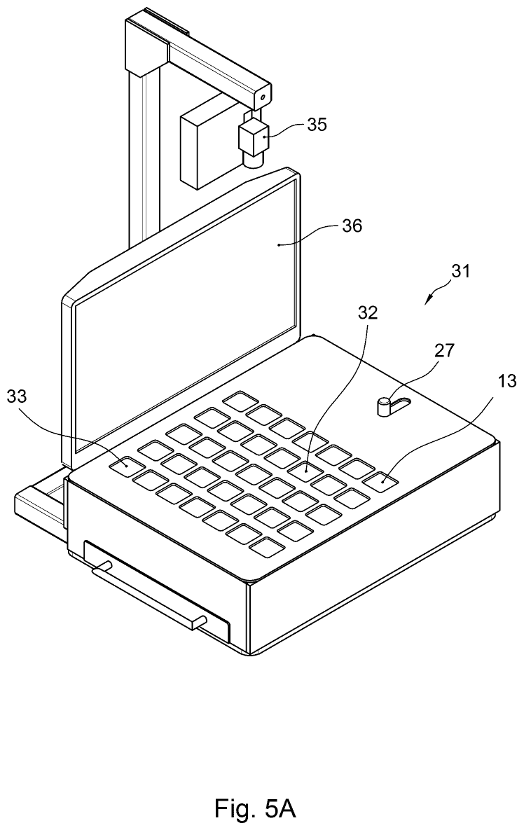

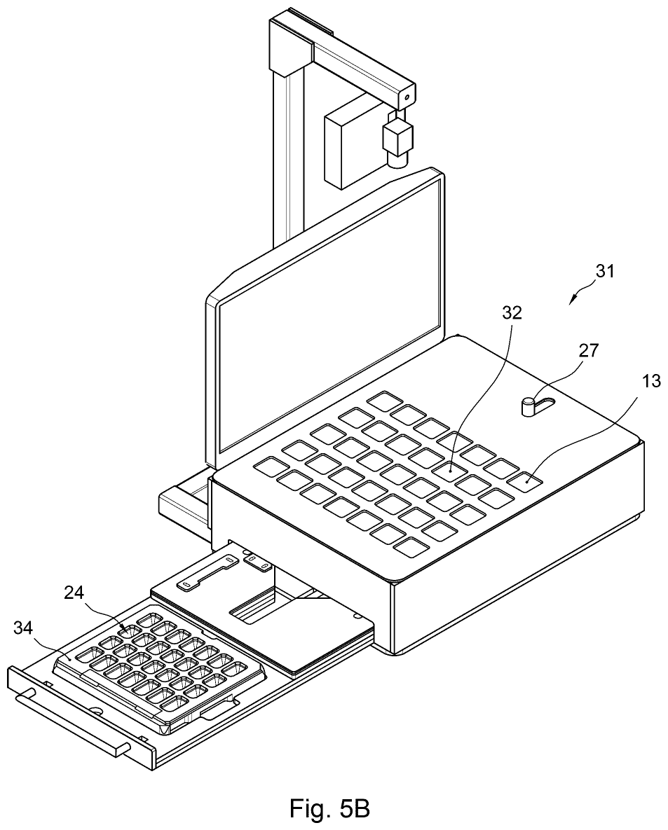

FIG. 5A and B shows isometric views of a medicine dose inspection device; and

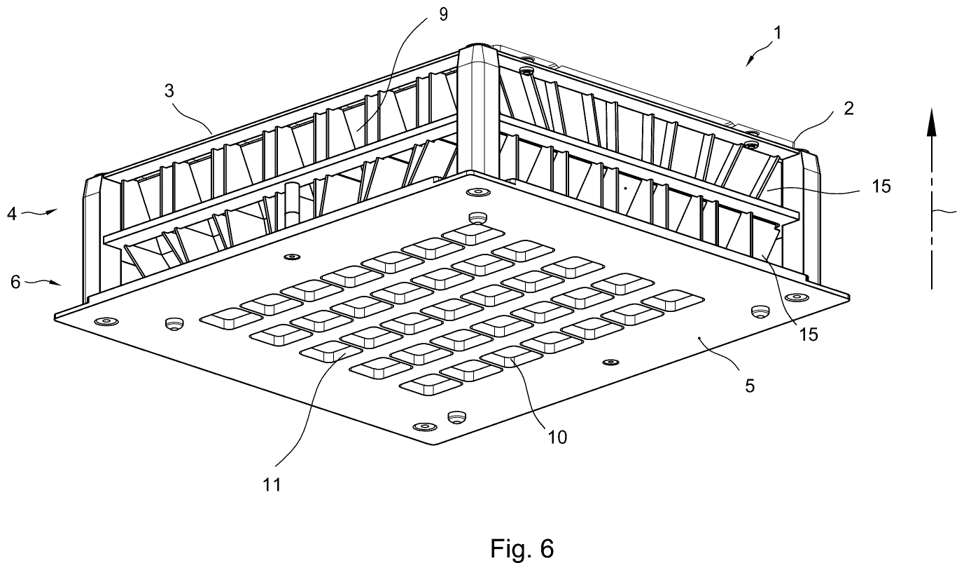

FIG. 6 shows an isometric bottom view of a further example of transfer device for transferring an array of doses of medicines.

It is noted that the figures are only schematic representations that are given by way of non-limited examples. In the figures, the same or corresponding parts are designated with the same reference numerals.

Referring to FIGS. 1, 2 and 3, a transfer device 1 for transferring an array of doses of medicines is depicted. The transfer device 1 comprises a body 2 extending along a main axis A1 between a top face 3 located at an upper part 4 of the body 2 and a bottom face 5 located at a lower part 6 of the body 2. The top face 3 includes a group of entrance openings 7 arranged in an entrance matrix 8 in a plane transverse to the main axis A1 at the level of the top face 3. The entrance openings 7 each are being arranged to receive a dose of medicines of the array. The body 2 comprises a bundle of channels 9 for passing doses of medicines therethrough, wherein each channel 9 extends along the body 2 from a single entrance opening 7 of the group of entrance openings to a single exit opening 10 of a group of exit openings arranged in an exit matrix 11 in a plane transverse to the main axis A1 of the body 2 at the level of the bottom face 5. At least one of the channels 9 extends along the body 2 with a component transverse to the main axis A1 of the body 2 so as to transpose the array of doses of medicines from a first spatial configuration corresponding to the entrance matrix 8 to a second spatial configuration corresponding to the exit matrix 11.

As an example to further clarify the workings of the transfer device 1, 35 doses of medicines (not depicted) comprising single or compound doses of medicines that may mutually differ in composition have been organized in a 5×7 array that corresponds to the entrance openings 7, have been disposed by a machine (not shown) in the array of medicines on the top face 3. When the 5×7 array passes through the entrance opening 7, each dose of medicine in the array corresponds to a single channel 9. In the example, relating to the device shown in FIGS. 1,2 and 3, the dose of medicines is then first forced by the shape of the channel 9 to translate in a first direction when it passes through the first half of the channel 9. When the dose of medicine arrives at the second half of the channel 9, the dose is forced by the shape of the channel 9 in a second direction which is perpendicular to the first direction. As a result, when the dose of medicine leaves the channel 9 via the exit opening 10, the dose of medicine is transferred relative to its first position in the plane of the array of medicines. As a result, it is possible to manipulate the distance between doses of medicines in the array of medicines without manual labo and with reduced chance of error.

The channels 9 of the bundle diverge relative to each other while extending from the entrance openings 7 to the exit openings 10. One of the channels 9, in the shown example the center-most channel, extends along the main axis A1 of the body 2 free of a component that is transverse to the main axis A1 of the body 2.

The entrance openings 7 of the entrance matrix 8 and the exit openings 10 of the exit matrix 11 are arranged on a pitch P in at least a first direction in the plane of the entrance matrix 8 and the exit matrix 11.

The transfer device 1 includes multiple stages 15 along its main axis A1. Each stage comprises two mutually transversely arranged sets of a number of mutually parallel planar strips 14. These planar strips 24 define the channels 9 by forming four circumferential walls 12. In the shown example of FIG. 3, two stages 15 can be seen, each with 24 planar strips 14. The top stage 15 is arranged to translate the doses of medicines along a first direction, while the bottom stag 15 is arranged to translate he doses of medicines along a second direction that is perpendicular to the first direction.

Referring to FIGS. 4A and 4B, a packaging device 21 is depicted. The packaging device 21 includes a frame 22 having a top 25 arranged to receive a first carrier 23. The first carrier has a matrix of cavities 24 that has a first spatial configuration. The packaging device 21 also includes a bottom 26 arranged to receive a second carrier 27 that also comprises a matrix of cavities 24 for receiving doses of medicines therein. The matrix of cavities 24 of the second carrier 27 has a second spatial configuration.

In addition, a transfer device 1 as described above has been included in the frame 2 with the openings 7 in its top face 3 arranged to cooperate with the cavities 24 of the first carrier 23. The openings 10 at the bottom face 5 are arranged to correspond with cavities 24 of the second carrier 27 so as to transpose an array of doses of medicines of the first carrier 23 from a first spatial configuration to a second spatial configuration. The second spatial configuration corresponds to the layout of the cavities 24 on the second carrier 27. It should be noted that the number of cavities 24 provides in the first carrier 23 does not need to correspond with the number of cavities 24 provided in the second carrier 27.

Furthermore, the entrance openings 7 of the transfer device 1 cooperate with a hatch 13, in the shown example provided in the first carrier 23. The hatch 13 is movable between a first state, in which it blocks the opening 7 of the corresponding channel 9, and a second state in which it leaves an opening free for medicines to pass through the channel 9. In the shown example, all hatches 13 can be simultaneously operated using a lever 27 provided on the frame 22 of the packaging device 21.

Referring to FIGS. 5A and 5B, a medicine dose inspection device 31 has been depicted. The medicine dose inspection device 31 comprises an inspection plane 32 with an inspection matrix of substantially planar inspection positions 33 on which doses of medicines may be placed to be inspected. The medicine dose inspection device 31 further comprises a transfer device 1 as described above that has a pitch P of the exit openings 10 in the plane of the exit matrix 11 reduced relative to the pitch P of the entrance openings 7 in the plane of the entrance matrix 8. The inspection positions 33 have been arranged to correspond with the entrance openings 7 of the entrance matrix 8. The inspection positions further comprise a hatch 13 that is movable between a first state in which it blocks its corresponding entrance opening 7 and a second state in which it leaves its corresponding entrance opening 7 free to allow passage of the dose of medicine.

The medicine dose inspection device 31 further comprises an inspected dose carrier 34 with a matrix of cavities 24 for receiving inspected doses of medicines therein. The inspection can be performed by an operator, that is able to inspect the doses of medicines that are displayed on a display 36, showing a video image from a camera 35 placed above the inspection plane 32. After the doses of medicines have been inspected, the operator is able to open the hatches 13 which are provided on the inspection positions 33, by actuating the lever 27, so that the doses of medicines are transferred to the inspected dose carrier 34.

Turning to FIG. 6 an isometric bottom view of a further example of transfer device 1 for transferring an array of doses of medicines is shown. Whereas in the example of FIG. 1 the channels 9 of the bundle diverge relative to each other while extending from the entrance openings 7 to the exit openings 10, the channels 9 of the bundle converge relative to each other while extending from the entrance openings 7 to the exit openings 10. Said convergence allows for the decrease in the pitch spacing and/or dimensions of the exit openings 10 in the plane of the exit matrix 11 relative to the spacing and/or dimensions of the entrance openings 7 in the plane of the entrance matrix 8. In the shown example, the convergence happens along both the X-axis and Y-axis, wherein the X-axis and Y-axis are parallel to the entrance matrix 8 and the exit matrix 11. However, it will be clear to the skilled person that the convergence can happen in one direction only, for example along an X-axis, diverge in another direction, for example a Y-axis. As a further alternative, convergence may be provided in a direction in the first stage 15 and divergence in the same direction in the second stage 15 or vice versa.

Many variations will be apparent to the skilled person in the art. For example, it will be clear to the person skilled that the art that a different number of stages 15 can be used, such as only one stage or a greater number than two. In addition, while in the shown embodiment specific configurations of cavities have been shown, it will be clear that any number and layout will be possible. Furthermore, it shall be understood that the lever used to open and/or close the hatches can be a physical lever, but also another type of opening device, e.g. a button or a computer program arranged to actuate a mechanism that can open/and/or close the hatches. Such variations are understood to be comprised within the scope of the invention as defined in the appended claims.

1. A transfer device for transferring an array of doses of medicines, the transfer device comprising a body extending along a main axis between a top face located at an upper part of the body and a bottom face located at a lower part of the body, the top face including a group of entrance openings arranged in an entrance matrix in a plane transverse to the main axis at the level of the top face, the entrance openings each being arranged to receive a dose of medicines of the array, the body comprising a bundle of channels for passing doses of medicines therethrough, each channel extending along the body from a single entrance opening of the group of entrance openings to a single exit opening of a group of exit openings arranged in an exit matrix in a plane transverse to the main axis of the body at the level of the bottom face, at least one of the channels extending along the body with a component transverse to the main axis of the body so as to transpose the array of doses of medicines from a first spatial configuration corresponding to the entrance matrix to a second spatial configuration corresponding to the exit matrix.

2. The transfer device of claim 1, wherein channels of the bundle diverge relative to each other while extending from the entrance opening to the exit opening.

3. The transfer device of claim 1, wherein channels of the bundle converge relative to each other while extending from the entrance opening to the exit opening.

4. The transfer device of claim 1, in which at least one of the channels extends along the main axis of the body free of component transverse to the main axis of the body.

5. The transfer device of claim 1, wherein channels are defined by one or more circumferential walls.

6. The transfer device of claim 1, wherein entrance openings of the entrance matrix and/or exit openings of the exit matrix are arranged on a pitch in at least first direction in the plane of the matrix.

7. The transfer device of claim 1, wherein channels, entrance openings and/or exit openings include or cooperate with a hatch that is movable between a first state in which it blocks an opening or channel for medicines and a second state in which it leaves an opening or channel free for medicines.

8. The transfer device of claim 1, in which the body includes two mutually transversely arranged sets of a number of mutually parallel planar strips to define openings and channels therebetween.

9. The transfer device of claim 1 in which the transfer device includes multiple stages along its main axis.

10. A packaging device, including a frame having a top arranged to receive a first carrier with a matrix of cavities for receiving doses of medicines therein having a first spatial configuration and a bottom arranged to receive a second carrier with matrix of cavities for receiving doses of medicines therein having a second spatial configuration and a transfer device according to claim 1, included in the frame with openings in its top face arranged to cooperate with cavities of the first carrier and openings in its bottom face arranged to correspond with cavities of the second carrier so as to transpose an array of doses of medicines of the first carrier from a first spatial configuration to a second spatial configuration.

11. A medicine dose inspection device comprising an inspection plane with an inspection matrix of substantially planar inspection positions on which doses of medicines may be paced to be inspected, and a transfer device according to claim 1, wherein a pitch, spacing and/or dimension of the exit openings in the plane of the exit matrix of the transfer device is reduced relative to the pitch, spacing and/or dimension of the entrance openings in the plane of the entrance matrix, the inspection positions being arranged to correspond with the entrance openings of the entrance matrix, wherein the inspection positions comprise a hatch that is movable between a first state in which it blocks its corresponding entrance opening and a second state in which it leaves its corresponding entrance opening free to allow passage of the dose of medicine, further comprising an inspected dose carrier with a matrix of cavities for receiving inspected doses of medicines therein.

12. A method of transferring medicines, using a transfer device according to claim 1, wherein doses of an array of doses of medicines are each passed through one of a bundle of channels having a main axis, at least one of the channels extending with a component of movement transverse to the main axis, so that the medicines are transposed from a first spatial configuration corresponding to an entrance matrix of entrance openings of the channels to a second spatial configuration corresponding to an exit matrix of openings of the channels.

13. The method of claim 12, wherein doses of medicine are passed through channels in a first stage of the bundle with a component of movement transverse to the main axis in first transverse direction only, and in a second stage with a component of movement transverse to the main axis in second transverse direction, perpendicular to the first direction only.
